(19) United States
(12) Patent Application Publication
(10) Pub. No.: US 2025/0272926 A1
(43) Pub. Date: Aug. 28, 2025

(54) AUGMENTED REALITY SYSTEM

(71) Applicant: Araizen Co., Ltd., Taipei City (TW)

(72) Inventors: Cheng-wei Hsu, Keelung City (TW); Hung-Kai Hsu, Keelung City (TW)

(21) Appl. No.: 18/740,248

(22) Filed: Jun. 11, 2024

(30) Foreign Application Priority Data
Feb. 23, 2024 (TW) 113201903

(51) Int. Cl. G06T 19/00

(52) U.S. Cl. CPC G06T 19/006

(57) ABSTRACT

An augmented reality system is provided, which includes: a management platform; a first user terminal communicating with the management platform, which includes: a positioning module for obtaining positioning information; an imaging module for capturing an environmental image from a physical environment; and a display module for displaying a virtual placement according to the positioning information and physical address information corresponding to the environmental image, wherein the virtual placement includes a first virtual object; and a setting terminal communicating with the management platform, which includes: a input module for inputting the physical address information, an identification image of an identification object, and the first virtual object; wherein the management platform sets the virtual placement according to the physical address information, the identification image, and the first virtual object.

### FIELD OF THE INVENTION

The present invention relates to an augmented reality technology, and more particularly to an augmented reality system with geographical relevance.

### BACKGROUND OF THE INVENTION

An augmented reality technology (AR, Augmented Reality) is a technology that can use a virtual object to add augmented information (such as visual information) to things seen in reality.

However, at present, the following issues exist in practical application of the augmented reality technology.

Geographical relevance: In existing technologies, the application of the augmented reality technology is usually limited to specific space (for example, be used only in space with a specific device/object), and has low geographical relevance with a physical environment (an application location is related to a location at which a device/object is placed, but not directly related to an actual geographical location), which limits an application scope of the augmented reality technology and make it difficult to promote the augmented reality technology to daily application or commercial application.

Interaction with users: The existing augmented reality technology usually only attaches augmented information to a specific object or scene. However, such information is usually just static supplementary information, and an augmented reality system usually does not support interaction among a plurality of users, which limits the application scope of the augmented reality technology, making it difficult to promote the augmented reality technology to the daily application or commercial application.

It can be learned from the above that there is still a lack of a technical architecture that can promote and popularize the augmented reality technology to the daily application and/or commercial application.

### SUMMARY OF THE INVENTION

In view of this, the present invention provides an augmented reality system. In the augmented reality system of the present invention, a setter may set a virtual placement at any place (a physical environment) through the management platform by using a terminal apparatus (a setting terminal, such as a mobile terminal or a fastened terminal) in advance, and a user may display the virtual placement by using a terminal apparatus (a first user terminal, such as a mobile terminal) at the corresponding place (the physical environment). Therefore, an application scope of an augmented reality technology is expanded, and the augmented reality technology is promoted to daily application.

The augmented reality system provided in the present invention includes: a management platform; a first user terminal, communicating with the management platform and including: a positioning module, configured to obtain positioning information; an imaging module, configured to capture a physical image from a physical environment; and a display module, configured to display a virtual placement according to the positioning information and physical address information corresponding to the physical image, where the virtual placement includes a first virtual object; and a setting terminal, communicating with the management platform and including: an input module, configured to input the physical address information, an identification image of an identification object, and the first virtual object, where the management platform sets the virtual placement according to the physical address information, the identification image, and the first virtual object.

In an embodiment of the present invention, in the augmented reality system, the first user terminal may further include an interactive module, configured to input a second virtual object corresponding to the first virtual object.

In an embodiment of the present invention, in the augmented reality system, the first user terminal may receive a proximity notification from the management platform based on a location-based service.

In an embodiment of the present invention, in the augmented reality system, the imaging module may scan the identification object to display the virtual placement.

In an embodiment of the present invention, in the augmented reality system, the first user terminal may transmit shared information, related to the first virtual object, to a second user terminal.

In an embodiment of the present invention, in the augmented reality system, the management platform may convert the physical address information into positioning information.

In an embodiment of the present invention, in the augmented reality system, the input module may be configured to input a display time period, and the display module may display the virtual placement according to the display time period.

To sum up, in the augmented reality system of the present invention, the setter may set the virtual placement at any place through the management platform by using the setting terminal in advance, and the user may display the virtual placement by using a terminal apparatus (the first user terminal) at the corresponding place. In this way, the augmented reality system according to the present invention can add augmented information to anything in life, and achieve the technical effect of extending an augmented reality technology to daily life and providing interactivity for the user.

To make the foregoing and other objects, features and advantages of the present invention more obvious and easy to understand, embodiments are provided in detail as follows with reference to the accompanying drawings.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a block diagram of an augmented reality system according to an embodiment of the present invention;

FIG. 2 is a flowchart of steps of a setting process according to an embodiment of the present invention; and

FIG. 3 is a flowchart of steps of a display process according to an embodiment of the present invention.

### DETAILED DESCRIPTION OF PREFERRED EMBODIMENTS

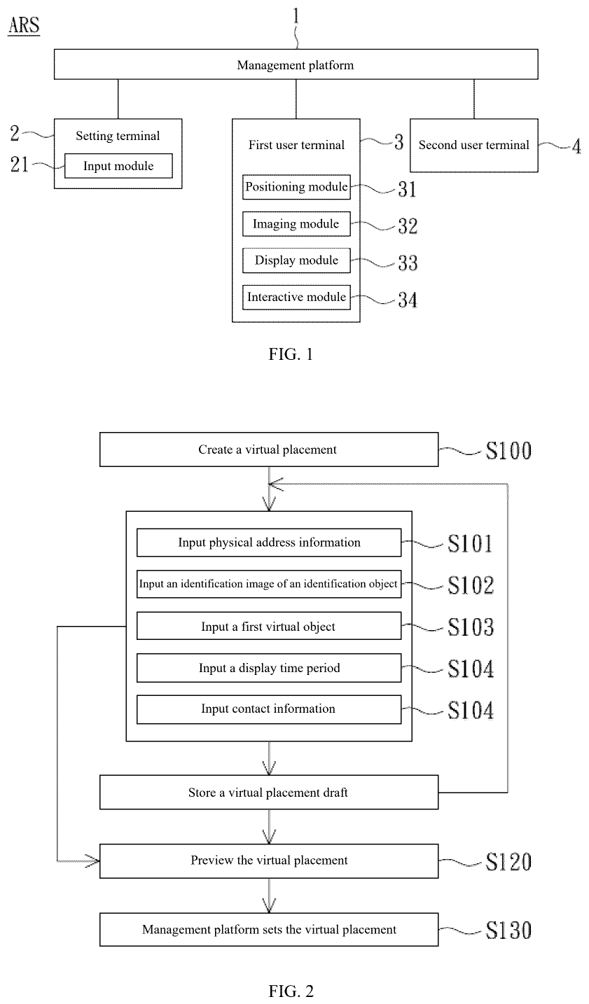

Refer to FIG. 1. FIG. 1 is a block diagram of an augmented reality system ARS according to an embodiment of the present invention.

In this embodiment, the augmented reality system ARS of the present invention includes: a management platform 1, a setting terminal 2, a first user terminal 3, and a second user terminal 4. The setting terminal 2 includes an input module 21, the first user terminal 3 includes a positioning module 31, an imaging module 32, a display module 33, and an interactive module 34, and the management platform communicates with the setting terminal 2, the first user terminal 3, and the second user terminal 4.

To prevent unclear definitions of terms, some terms used in the embodiment of the present invention are explained below.

In this embodiment, the augmented reality system ARS includes the management platform 1. For example, the management platform 1 may include a server, and a user may access a function/data provided by the management platform 1 through a network connection. The management platform 1 may transmit: a corresponding instruction/corresponding data (such as a return instruction, user interface setting of a user application, user data, and the like) in response to actions (such as a requesting instruction to request transmission, access, and the like of specific data to the management platform 1) of the setting terminal 2, the first user terminal 3, and the second user terminal 4. In one embodiment, the management platform 1 may transmit a proximity notification to the setting terminal 2, the first user terminal 3, and the second user terminal 4 based on an LBS (Location-Based Service). In one embodiment, the management platform 1 includes an account management system to manage account registration, account cancellation, account information, and the like of the setting terminal 2, the first user terminal 3, and the second user terminal 4.

In this embodiment, the augmented reality system ARS includes: the setting terminal 2, the first user terminal 3, and the second user terminal 4. For example, the setting terminal 2 may be a mobile terminal (such as a smart phone, a tablet computer, a notebook computer, and the like) or a fastened terminal (such as a personal computer); and the first user terminal 3 and the second user terminal 4 may be, for example, mobile terminals (such as smart phones, tablet computers, AR head-mounted devices, MR head-mounted devices, and the like). Based on the above, hardware architectures of the setting terminal 2, the first user terminal 3, and the second user terminal 4 may be the same or different, and the present invention is not limited thereto. The first user terminal 3 and the second user terminal 4 are configured to distinguish terminal apparatuses used by different users. In one embodiment, the positioning module 31 may be, for example, an assembly, in a smart phone, that obtains positioning information related to a geographical location by using a positioning system such as Global Positioning System (GPS), Beidou Navigation Satellite System (BDS), or Geographical Information Positioning (GEO). The imaging module 32 may be, for example, a camera apparatus configured on a smart phone. The display module 33 may be, for example, a display panel configured on the smart phone. The interactive module 34 may be, for example, a touch panel configured on the smart phone, and may be configured to draw/input a second virtual object corresponding to a first virtual object. The input module 21 may be, for example, a keyboard or a mouse configured on a personal computer, or a touch panel configured on a smart phone.

In addition, in this embodiment, the setting terminal 2 and the first user terminal 3 may be the same terminal devices, or may be different devices. For example, the mobile terminal (such as the smart phone) used by the user can simultaneously serve as the setting terminal 2 and the first user terminal 3 of the present invention. When performing a virtual placement setting process, the mobile terminal may be regarded as the setting terminal 2. When displaying a preset virtual placement, the mobile terminal may be regarded as the first user terminal 3.

For example, a merchant may use the augmented reality system ARS of the present invention (the use of the present invention is not limited to the merchant. In one embodiment, ordinary people without a legal person status may also use the augmented reality system ARS of the present invention, and the present invention is not limited thereto). The setting terminal 2, the first user terminal 3, and the second user terminal 4 may communicate with the management platform 1 through a wireless network (for example, a wireless local area network, a wireless wide area network) or a wired network. The first user terminal 3 and the second user terminal 4 are preferably communicated through the wireless network. The setting terminal 2 may be disposed in the merchant, and the setting terminal 2 may input physical address information (for example, a store address of the merchant), an identification image (for example, image data of a signboard of the merchant, or image data that has a geographical signature and can be used to identify an indicator of the merchant) of an identification object, and the first virtual object (for example, a custom object of the merchant, which is a virtual object that may be applied to the augmented reality system ARS, and the virtual object may include a two-dimensional (2D) image, and/or a three-dimensional image including a three-dimensional (3D) module) by using the input module 21. The management platform may set a virtual placement based on the physical address information, the identification image, and the first virtual object, so that the merchant may preset the virtual placement at a desired location by using the setting terminal 2. The positioning module 31 of the first user terminal 3 may obtain the positioning information, corresponding to a physical location (geographic location), of the first user terminal 3 and that is used to display a location of the first user terminal 3. The imaging module 32 of the first user terminal 3 can acquire an environmental image of a physical environment, and the display module 33 of the first user terminal 3 can display a virtual placement preset by the setting terminal 2 according to the positioning information and the physical address information that is corresponding to the environmental image. For example, the first user terminal 3 may directly display the virtual placement at a specific longitude and latitude without scanning a specific identification image, or the first user terminal 3 may present, by scanning the identification image, the virtual placement after entering a specific area (a radius of n meters at the specific longitude and latitude)

In this embodiment, the augmented reality system ARS of the present invention provides a setting process and display process of the virtual placement.

Refer to FIG. 2. FIG. 2 is a flowchart of steps of a setting process according to an embodiment of the present invention. The setting process may be performed, for example, by a management platform 1. The setting process of an augmented reality system ARS includes the following.

Step S100: Create a virtual placement. For example, in the setting terminal 2, a setting application program may be obtained from the management platform 1. The setting application program may include a setting interface and may be used to set the virtual placement. A setter may open the setting application program in the setting terminal 2, and create a setting page corresponding to the virtual placement in the setting application program. The setter may set a plurality of pieces of setting information for the virtual placement in the setting page. In one embodiment, a user may create a plurality of virtual placements.

Step S101: Input physical address information, where the setter may input a plurality of pieces of setting information (physical address information) by using an input module 21, and transmitting the physical address information (such as a store address of a merchant) to the management platform 1. In one embodiment, the management platform 1 may further convert the physical address information into positioning information, for example, convert the physical address information into the positioning information that conforms to a data format of the Global Positioning System (GPS).

Step S102: Input an identification image of an identification object. The setter may input setting information (the identification image) by using the input module 21. All physical objects within a specific distance range from the physical address information may be used as the identification object. For example, an imaging range of an imaging module 32 includes both a merchant's store and a distance from the identification object, that is, an environmental image includes a physical object corresponding to the physical address information and the identification object, and in one embodiment, the physical object corresponding to the physical address information may also be used as the identification object. For example, when the setter is the merchant, the identification object may be a part (such as a store sign) of the store or a landmark indicator (such as a well-known landmark or object located near the store, which may be a subway station, mailbox, giant rock in natural landscape, or the like near the store). A user of a first user terminal 3 may scan the identification object to display a virtual placement.

Step S103: Input the first virtual object. The setter may input setting information (the first virtual object) by using the input module 21. For example, the setter may prepare in advance virtual object data that may be used for an augmented reality system ARS. The virtual object data may include two-dimensional (2D) image data, and/or three-dimensional object data composed of a three-dimensional (3D) module. A display module 33 of the first user terminal 3 may display the first virtual object according to the virtual object data.

Step S104: Input a display time period. The setter may input setting information (the display time period) by using the input module 21. For example, the setter may set the display time period, and the display module 33 of the first user terminal 3 displays the virtual placement according to the input display time period. The display time period be unit duration (for example: 5 minutes, 1 hour, 1 day, 1 month, and the like), or a time period including opening time and end time (for example: a time period from 10 a.m. to 2 p.m.).

Step S105: Input contact information. The setter may input setting information (contact information) by using the input module 21. For example, the setter may provide contact information such as a merchant name, a contact number, and a contact address, and the display module 33 of the first user terminal 3 may display the contact information, so that the user may obtain detailed information about the virtual placement.

Step S110: Store a virtual placement draft. For example, before the setter believes that a virtual placement has not been set up yet, a virtual placement containing partially completed setting information may be stored as the virtual placement draft in the management platform 1 or the setting terminal 2, so that the setter can re-edit the virtual placement.

Step S120: Preview the virtual placement. The setting terminal 2 may display the virtual placement to preview a completed state of the virtual placement.

Step S130: The management platform sets the virtual placement. The management platform 1 sets the virtual placement based on a plurality of pieces of setting information (physical address information, identification image, a first virtual object, a display time period, contact information, and the like) input by the setter.

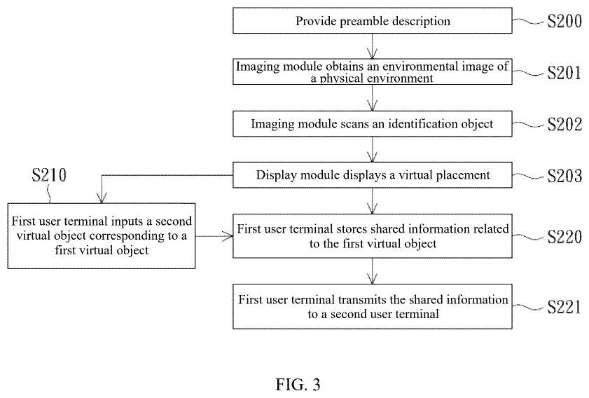

Refer to FIG. 3. FIG. 3 is a flowchart of steps of a display process according to an embodiment of the present invention. The display process may be performed, for example, by a management platform 1. A display process of an augmented reality system ARS includes the following.

Step S200: Provide preamble description. For example, a first user terminal 3 may obtain a display application program from the management platform 1, and the user may use the augmented reality system ARS of the present invention by using the preamble description in the display application program. Step S201: An imaging module obtains an environmental image of a physical environment.

Step S202: An imaging module scans an identification object.

Step S203: A display module displays a virtual placement.

For example, the imaging module 32 of the first user terminal 3 may obtain an environmental image (the environmental image of the physical environment) of a place, and a positioning module 31 of the first user terminal 3 may obtain positioning information. When the user of the first user terminal 3 is located near physical address information, the user may scan the identification object preset by a setter by using the imaging module 3, so that the display module 33 displays the virtual placement. For example, the first user terminal 3 may directly display the virtual placement at a specific longitude and latitude without scanning a specific identification image, or the first user terminal 3 may present, by scanning the identification image, the virtual placement after entering a specific area (a radius of n meters at the specific longitude and latitude). In one embodiment, the management platform 1 may further generate, according to a building in a physical environment, a third virtual object corresponding to the building, and the virtual placement may further include a third virtual object. The third virtual object is a 3D virtual object.

Step S210: The first user terminal inputs a second virtual object corresponding to the first virtual object. The user of the first user terminal 3 may input the second virtual object by using an interactive module 34. For example, when the display module 33 of the first user terminal 3 displays the virtual placement, the user may draw the second virtual object by using a touch module of a smartphone, and save the second virtual object in the management platform 1. Another user (such as a second user terminal 4) can display the second virtual object at a same location, thereby improving interactivity between a plurality of users of the augmented reality system ARS of the present invention.

Step S220: The first user terminal stores shared information related to the first virtual object.

Step S221: The first user terminal transmits the shared information to the second user terminal.

For example, the first user terminal 3 may store an environmental image including the virtual placement, and then transmit the environmental image including the virtual placement to the user terminal 4 (the first user terminal 3 transmits the shared information related to the first virtual object to the second user terminal 4). The shared information may include the first virtual object and/or the second virtual object, thereby providing interactivity between a plurality of users of the augmented reality system ARS. In one embodiment, the management platform 1 may send a reward token to the user of the first user terminal 3 according to a sharing behavior of the first user terminal 3, to increase user's willingness to use the augmented reality system ARS.

To sum up, in the augmented reality system of the present invention, the setter may set the virtual placement at any place through the management platform by using the setting terminal in advance, and the user may display the virtual placement by using a terminal apparatus (the first user terminal) at the corresponding place. In this way, the augmented reality system according to the present invention can add augmented information to any thing in life, and achieve the technical effect of extending an augmented reality technology to daily life and providing interactivity for the user.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An augmented reality system, comprising:
a management platform;
a first user terminal, communicating with the management platform and comprising:
a positioning module, configured to obtain positioning information;
an imaging module, configured to capture an environmental image from a physical environment; and
a display module, configured to display a virtual placement according to the positioning information and physical address information corresponding to the environmental image, wherein the virtual placement comprises a first virtual object; and
a setting terminal, communicating with the management platform and comprising:
an input module, configured to input the physical address information, an identification image of an identification object, and the first virtual object,
wherein the management platform sets the virtual placement according to the physical address information, the identification image, and the first virtual object.

2. The augmented reality system according to claim 1, wherein the first user terminal further comprises an interactive module configured to input a second virtual object corresponding to the first virtual object.

3. The augmented reality system according to claim 1, wherein the first user terminal receives a proximity notification from the management platform based on a location-based service.

4. The augmented reality system according to claim 1, wherein the imaging module scans the identification object to display the virtual placement.

5. The augmented reality system according to claim 1, wherein the first user terminal transmits shared information, related to the first virtual object, to a second user terminal.

6. The augmented reality system according to claim 1, wherein the management platform converts the physical address information into positioning information.

7. The augmented reality system according to claim 1, wherein the input module is configured to input a display time period, and the display module displays the virtual placement according to the display time period.
